(19) United States
(12) Patent Application Publication
(10) Pub. No.: US 2008/0155416 A1
(43) Pub. Date: Jun. 26, 2008

(54) Volume control method and information processing apparatus

(75) Inventor: Hitoshi Oitaira, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/976,153

(22) Filed: Oct. 22, 2007

(30) Foreign Application Priority Data
Dec. 25, 2006 (JP) 2006-348364

(51) Int. Cl. G06F 3/048

(52) U.S. Cl. 715/716

(57) ABSTRACT

According to one embodiment, an information processing apparatus includes an audio output unit which outputs input audio data, a display, a user interface displaying unit which displays, on the display, a volume control user interface for controlling volume of the audio data output from the audio output unit, a storing unit which stores audio sample data, a volume controlling unit which controls the volume of the audio data output from the audio output unit in accordance with a volume control operation by a user via the volume control user interface, and an audio sample data supplying unit which supplies, to the audio output unit, the audio sample data stored in the storing unit during the volume control operation.

### CROSS-REFERENCE TO RELATED APPLICATIONS

This application is based upon and claims the benefit of priority from Japanese Patent Application No. 2006-348364, filed Dec. 25, 2006, the entire contents of which are incorporated herein by reference.

### BACKGROUND

1. Field

One embodiment of the present invention relates to a volume control method using a user interface and an information processing apparatus including a volume control function using a user interface.

2. Description of the Related Art

Conventionally, various kinds of software and hardware have been proposed which include volume control functions. For example, generally, an operating system (OS) includes a volume control function, and the volume control function is provided as a user interface. The user interface is displayed on a display of an information processing apparatus on which the OS is installed or a display connected to the information processing apparatus. The user interface includes, for example, a slider bar for controlling the volume. In this case, a user can control the volume output from the information processing apparatus by moving a slider of the slider bar to right and left by a mouse. Additionally, Japanese Patent Application KOKAI Publication No. 2003-152826 describes a technique for selecting and determining an optimum volume while actually listening to a sample sound by operating a volume control key, which is provided in a mobile phone, after performing a selection of alarm sound, a selection of ring alert, or a selection of incoming mail alert.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram schematically showing a configuration of an information processing apparatus according to a first embodiment of the invention;

FIG. 2 is an exemplary schematic diagram for explaining a volume control function of the information processing apparatus shown in FIG. 1;

FIG. 3 is an exemplary block diagram schematically showing a configuration of an IP telephone software shown in FIG. 1;

FIG. 4 is an exemplary schematic diagram showing an example of a volume control user interface provided by the IP telephone software shown in FIG. 1;

FIG. 5 is an exemplary schematic diagram showing another example of the volume control user interface provided by the IP telephone software shown in FIG. 1;

FIG. 6 is an exemplary schematic diagram showing still another example of the volume control user interface provided by the IP telephone software shown in FIG. 1;

FIG. 7 is an exemplary flowchart for explaining a volume control method according to a second embodiment of the invention;

FIG. 8 is an exemplary flowchart for explaining a specific exemplary application of the volume control method according to the second embodiment of the invention;

FIG. 9 is an exemplary flowchart for explaining another specific exemplary application of the volume control method according to the second embodiment of the invention; and

FIG. 10 is an exemplary flowchart for explaining still another specific exemplary application of the volume control method according to the second embodiment of the invention.

### DETAILED DESCRIPTION

Various embodiments according to the invention will be described hereinafter with reference to the accompanying drawings. In general, according to one embodiment of the invention, an information processing apparatus includes: an audio output unit which outputs input audio data; a display; a user interface displaying unit which displays, on the display, a volume control user interface for controlling volume of the audio data output from the audio output unit; a storing unit which stores audio sample data; a volume controlling unit which controls the volume of the audio data output from the audio output unit in accordance with a volume control operation by a user via the volume control user interface; and an audio sample data supplying unit which supplies, to the audio output unit, the audio sample data stored in the storing unit during the volume control operation.

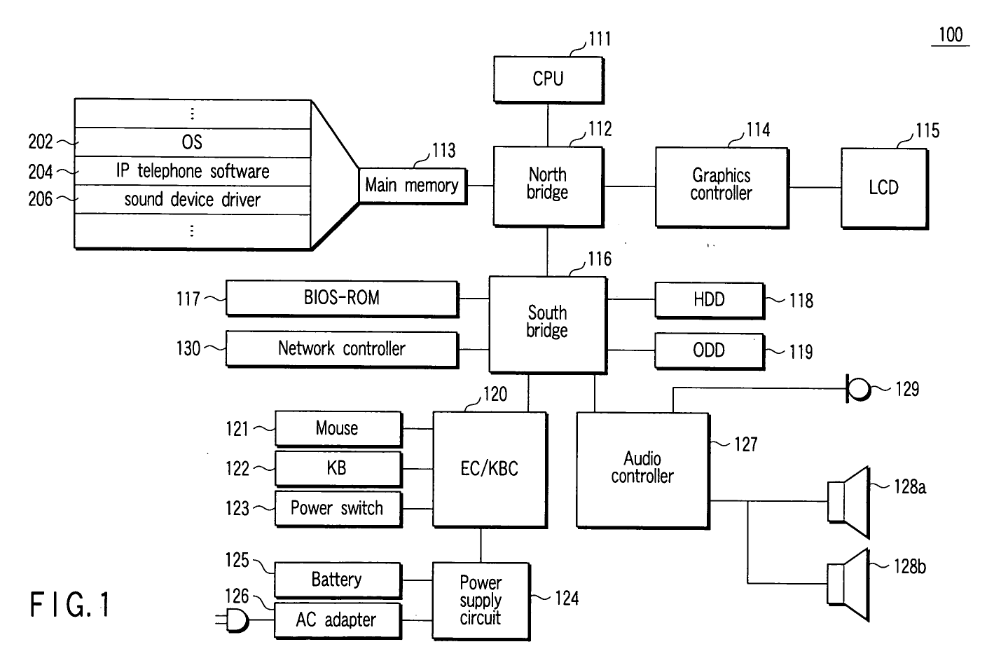

Referring to FIG. 1, a description is given of an information processing apparatus according to a first embodiment of the invention. The information processing apparatus may be an arbitrary information processing apparatus including a function of outputting sound, such as a notebook personal computer and a desktop personal computer. The information processing apparatus may be provided with built-in speakers or connected to external speakers. For convenience of explanation, the information processing apparatus is realized herein as a notebook personal computer (hereinafter referred to as “the notebook PC”) 100 provided with built-in speakers.

FIG. 1 is an exemplary schematic diagram schematically showing a configuration of the notebook PC 100. As shown in FIG. 1, the notebook PC 100 includes a CPU 111, a north bridge 112, a main memory 113, a graphics controller 114, a liquid crystal display (LCD) 115, a south bridge 116, a BIOS-ROM 117, a hard disk drive (HDD) 118, an optical disk drive (ODD) 119, an embedded controller/keyboard controller IC (EC/KBC) 120, a mouse 121, a keyboard (KB) 122, a power switch 123, a power supply circuit 124, a battery 125, an AC adapter 126, an audio controller (audio output unit) 127, speakers 128a and 128b, a microphone 129, a network controller 130, etc. Although the two speakers 128a and 128b are shown in FIG. 1, the notebook PC 100 may include a single speaker.

The CPU 111 is a processor which controls an operation of the notebook PC 100. The CPU 111 executes an operating system (OS) and various kinds of application programs, such as an IP telephone software 204 and a sound device driver 206, which are loaded from the HDD 118 to the main memory 113. Additionally, the CPU 111 also executes a BIOS (Basic Input/Output System) stored in the BIOS-ROM 117. The BIOS is a program for controlling peripheral devices, and is initially executed when the notebook PC 100 is turned ON.

The north bridge 112 is a bridge device connecting a local bus of the CPU 111 to the south bridge 116. The north bridge 112 includes a function of performing communication with the graphics controller 114 via, for example, an AGP (Accelerated Graphics Port) bus. The graphics controller 114 is a display controller controlling the LCD 115 of the notebook PC 100. The graphics controller 114 generates a display signal to be output to the LCD 115 from display data which are generated by the OS 202 or the application programs.

The south bridge 116 is connected to the BIOS-ROM 117, the HDD 118, the ODD 119, the audio controller 127, the EC/KBC 120, and the network controller 130. Additionally, the south bridge 116 incorporates therein an IDE (Integrated Drive Electronics) controller for controlling the HDD 118 and the ODD 119.

The EC/KBC 120 is a one-chip microcomputer where an embedded controller (EC) for power management and a keyboard controller (KBC) for controlling the mouse 121 and the keyboard (KB) 122 are integrated. The EC/KBC 120 is always turned ON by power from the power supply circuit 124, irrespective of whether or not the notebook PC is turned ON. In response to an operation of the power switch 123 by a user, the EC/KBC 120 performs a process of turning ON or OFF the notebook PC 100 in combination with the power supply circuit 124. When the external power is not supplied, the notebook PC 100 is driven by the battery 125. When external power is supplied via the AC adapter 126, the notebook PC 100 is driven by the external power.

The audio controller 127 outputs input audio data (audio signal). The audio data is converted from a digital format to an analog format by, for example, an audio codec. The converted audio data is output to the speakers 128a and 128b via, for example, amplifiers. Additionally, the audio controller 127 performs a process of receiving, for example, via the audio codec, the audio signal which is input from the microphone 129. In this case, the audio signal which is input from the microphone 129 is converted from an analog format to a digital format, and then sent to the audio controller 127.

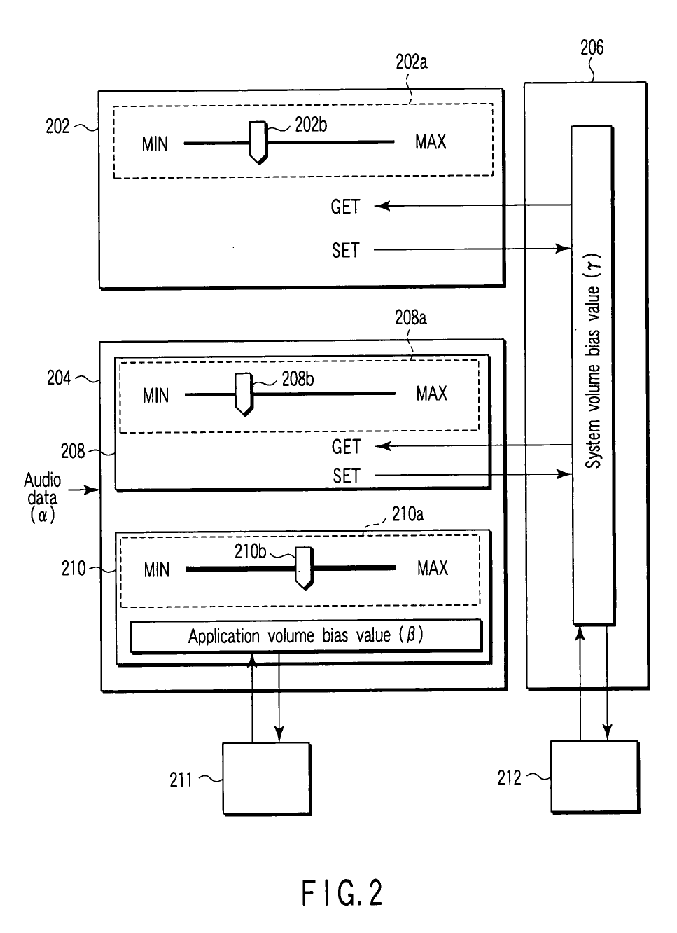

Referring to FIG. 2, a description is given of a volume control function of the notebook PC 100 shown in FIG. 1.

FIG. 2 shows the OS 202 (specifically, a volume control user interface provided by the OS 202), the IP telephone software 204 (specifically, a volume control user interface provided by the IP telephone software 204), the sound device driver 206, a registry 211 for the IP telephone software 204, a registry 212 for the sound device driver 206. The registries 211 and 212 are realized as a part of a storage area of the HDD 118 shown in FIG. 1.

Generally, when controlling the volume output from the speakers 128a and 128b of the notebook PC 100, the user performs an operation for displaying on the LCD 115 the volume control user interface of the OS 202. The volume control user interface of the OS 202 includes a slider bar 202a and a slider 202b which is slidable by a user operation. The slider bar 202a and the slider 202b indicate the volume which is currently set to the notebook PC 100, and function as a volume indicator which enables the user to perform a volume control operation. The volume control user interface of the OS 202 obtains, from the registry 212 via the sound device driver 206, the volume currently set to the notebook PC 100 (“GET” in FIG. 2), and displays the slider 202b at the position corresponding to the obtained volume. The user can perform the volume control operation by dragging and moving the slider 202b by the mouse 121 or the like to the right side (maximum volume: MAX) or to the left side (minimum volume: MIN) of FIG. 2. The controlled volume is supplied to the sound device driver 206 from the volume control user interface of the OS 202 (“SET” in FIG. 2). The sound device driver 206 controls the supplied volume at a system level, and outputs audio data to the speakers 128a and 128b with the controlled volume. The volume supplied from the volume control user interface of the OS 202 to the sound device driver 206 is stored in the registry 212 by the sound device driver 206.

On the other hand, when controlling the volume output from the speakers 128a and 128b of the notebook PC 100 by using the IP telephone software 204, the user performs an operation for displaying on the LCD 115 the volume control user interface provided by the IP telephone software 204. The volume control user interface of the IP telephone software 204 includes two kinds of volume control functions: a first volume control function which sets the volume of the notebook PC 100 by utilizing an audio mixer API of the OS 202; and a second volume control function which controls volume in accordance with a value managed by the IP telephone software 204.

The first volume control function is a function similar to that of the above-mentioned volume control user interface of the OS 202. That is, the volume control user interface of the IP telephone software 204 includes a slider bar 208a and a slider 208b which is slidable by a user operation. The slider bar 208a and the slider 208b indicate the volume output from the speakers 128a and 128b of the notebook PC 100 when using an IP telephone function of the IP telephone software 204, and function as a volume indicator which enables the user to perform the volume control operation. When using the IP telephone function of the IP telephone software 204, the sound to be output from the speakers 128a and 128b is audio data (a) of a called party of a telephone call from the user of the notebook PC 100. The audio data are supplied to the notebook PC 100 via an IP telephone network from, for example, a telephone used by the called party or a personal computer on which an IP telephone software is installed. The volume control user interface of the IP telephone software 204 obtains the volume currently set to the notebook PC 100 from the registry 212 via the sound device driver 206 (“GET” in FIG. 2), and displays the slider 208b at the position corresponding to the obtained volume. By dragging and moving the slider 208b by the mouse 121 or the like to the right side (maximum volume: MAX) or to the left side (minimum volume: MIN) of FIG. 2, the user can control the volume at the time when the IP telephone function is used. The controlled volume is supplied from the volume control user interface of the IP telephone software 204 to the sound device driver 206 (“SET” in FIG. 2). The supplied volume is stored in the registry 212.

The second volume control function also provides a volume control user interface including a slider bar 210a and a slider 210b. The slider bar 210a and the slider 210b indicate the volume output from the speakers 128a and 128b of the notebook PC 100 when using the IP telephone function of the IP telephone software 204, and function as a volume indicator which enables the user to perform the volume control operation. Additionally, the audio data (α) of the called party supplied to the notebook PC 100 from the IP telephone network is controlled by the IP telephone software 204 by using an application volume bias value (β), and is supplied to the sound device driver 206. If an application volume bias value (β) is changed, it is stored in the registry 211 by the volume control user interface of the IP telephone software 204. The sound device driver 206 controls the volume (α+β) supplied from the volume control user interface of the IP telephone software 204 at a system level, and outputs the audio data from the speakers 128a and 128b with the controlled volume. That is, the volume of the audio data output from the speakers 128a and 128b is volume based on α, β and γ.

The above-mentioned second volume control function performs volume control by the IP telephone software 204. A control value is stored in the registry 211 which is managed by the IP telephone software 204, and the sound device driver 206 is not notified of the control value. The control value is represented herein as the application volume bias value (β).

In computers, sound is represented by a PCM value, which ranges from −32768 to 32768 when expressed in 16 bit. Since the volume is expressed in absolute value, the volume ranges from 0 to 32768. For example, in the case where the application volume bias value (β) is 1000 and a system volume bias value (γ) is 500, when the audio data (α) received from the called party is 20000, audio data to be output is 20000+1000+500=21500.

The audio data (α) are received sound and can be expressed in a PCM value, whereas the application volume bias value (β) and the system volume bias value (γ) are amounts for increasing or decreasing the original sound. The application volume bias value (β) is a value managed by the application, and the system is not notified of the application volume bias value (β).

In FIG. 2, for convenience of explanation, the volume indicator (208a and 208b) for the first volume control function and the volume indicator (210a and 210b) for the second volume control function are shown as different volume indicators. However, in practice, the volume control user interface of the IP telephone software 204 may include a single volume indicator.

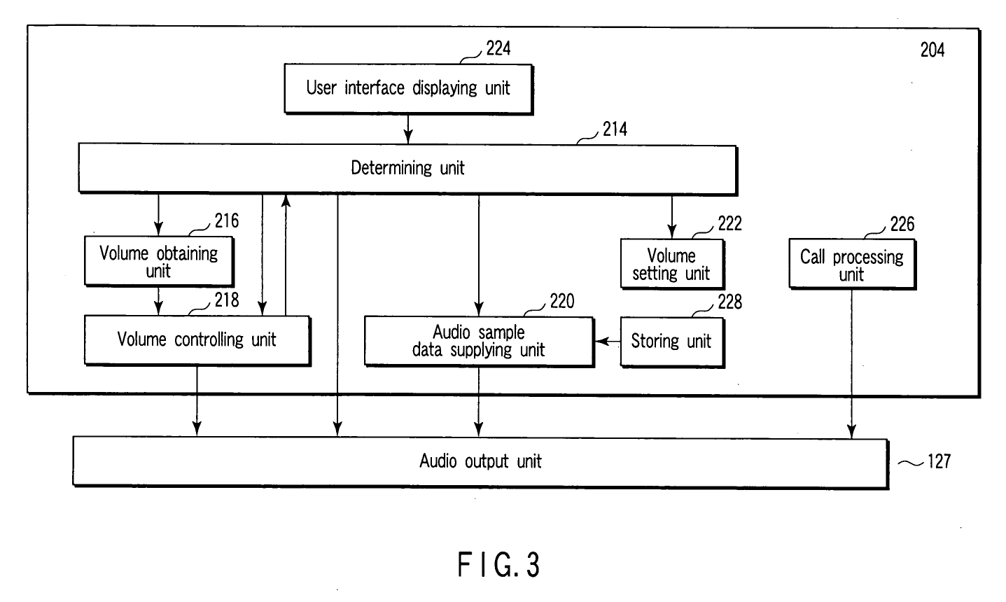

Referring to FIG. 3, a description is given of a configuration of the IP telephone software 204.

FIG. 3 is an exemplary block diagram schematically showing a configuration of the IP telephone software 204. As shown in FIG. 3, the IP telephone software 204 includes a determining unit 214, a volume obtaining unit 216, a volume controlling unit 218, a sound sample data supplying unit 220, a volume setting unit 222, a user interface displaying unit 224, a call processing unit 226, storing unit 228, etc.

The determining unit 214 determines whether or not the volume indicator included in the volume control user interface of the IP telephone software 204 is operated by the user, i.e., whether the volume control operation by the user is started. The determination is conducted based on, for example, a signal supplied from the OS 202. After determining that the volume control operation by the user is started, the determining unit 214 determines whether or not the volume control operation by the user is ended (whether or not the volume control operation by the user is continued). When the volume control operation by the user is not ended, in other words, during the volume control operation by the user, the determining unit 214 supplies, to the volume controlling unit 218, information based on the volume control operation by the user. Further, when it is determined that the volume control operation by the user is ended, the determining unit 214 gives an instruction to the sound sample data supplying unit 220 to stop output of sound sample data. Additionally, when the volume control operation by the user is ended, the determining unit 214 supplies, to the sound device driver 206 via the volume setting unit 222, the volume which is set by the volume control operation, or sets the volume to the registry 211.

The volume control operation is performed by the user by operating a portion (e.g., the slider 208b shown in FIG. 2) which can be operated by the user by using the mouse 121 or the like in the volume indicator (e.g., the slider bar 208a and the slider 208b) included in the volume control user interface. More specifically, the volume control operation is performed by, for example, dragging the slider 208b by the user by using the mouse 121 or the like.

When the determining unit 214 determines that the volume control operation is started, the volume obtaining unit 216 obtains the volume currently set to the notebook PC 100 (when the first volume control function is implemented by the IP telephone software 204) or the volume currently set to the IP telephone software 204 (when the second volume control function is implemented by the IP telephone software 204). The volume obtaining unit 216 supplies the obtained volume to the volume controlling unit 218.

The volume controlling unit 218 controls the volume of the audio data output from the audio output unit 127 in accordance with the volume control operation by the user via the volume control user interface. Additionally, the volume controlling unit 218 controls the volume of the audio data output from the audio output unit 127 based on the information supplied from the determining unit 214 in a time period since the volume control operation is started until the volume control operation is ended (i.e., during the volume control operation). In other words, the volume controlling unit 218 controls the volume of the audio data output from the audio output unit 127 to volume corresponding to the value controlled by the volume control operation by the user. The information supplied from the determining unit 214 includes information indicating the operation by the user with respect to the volume indicator included in the volume control user interface of the IP telephone software 204. For example, in the case where the volume indicator is a slider bar, the information may be the position of a slider. Additionally, in the case where the volume indicator is a button, the information may be the time length the button is pressed (clicked) or the number of times the button is pressed. Further, in the case where the volume indicator is a dial which is rotatable by the user, the information may be the position or angle of the dial. In any case, the volume controlling unit 218 supplies the controlled volume to the audio output unit 127.

The volume control performed by the volume controlling unit 218 can employ either a method of controlling the audio controller 127 or a method of varying the value of the audio data to be output.

The audio sample data supplying unit 220 supplies audio sample data stored in the storing unit 228 to the audio output unit 127 during the volume control operation by the user. The storing unit 228 can store a plurality of kinds of audio sample data.

The audio output unit 127 outputs the audio sample data supplied from the audio sample data supplying unit 220 with the volume supplied from the volume controlling unit 218. In addition, the audio output unit 127 outputs the audio data supplied from the call processing unit 226 with the volume supplied from the volume controlling unit 218.

When making a call by using the IP telephone function of the IP telephone software 204, the audio data of the called party is output from the speakers 128a and 128b with the controlled volume.

Additionally, as for the plurality of kinds of audio sample data stored in the storing unit 228, various kinds of audio sample data can be used such as music, beep sound, audio sample data of repeatedly calling the same word, audio sample data of reading a story aloud, audio sample data including both human voice and background noise (e.g., sound of machine tool), etc. In this case, the volume control user interface of the IP telephone software 204 may be provided with a function which enables the user to select one of the plurality of kinds of audio sample data. Alternatively, one of the plurality of kinds of audio sample data may be sequentially selected when outputting the audio sample data. When the volume control user interface of the IP telephone software 204 is provided with such a function, the user can control the volume of the notebook PC 100 to volume suitable for an environment where the user makes a call. Further, the audio data of a person who talked with the user over the telephone may be recorded, and the recorded audio data may be used as the audio sample data. In this case, it is possible to set the volume in an environment closer to an environment where an actual call is made with the person.

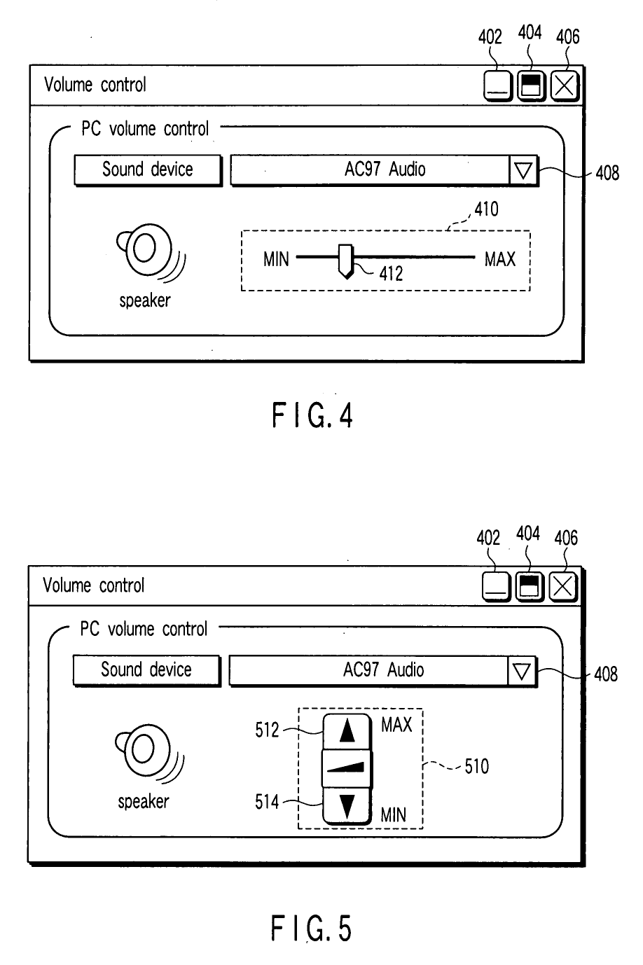

Referring to FIGS. 4, 5 and 6, a description is given of the volume control user interface provided by the IP telephone software 204.

FIG. 4 is an exemplary schematic diagram showing an example of the volume control user interface provided by the IP telephone software 204. The volume control user interface shown in FIG. 4 includes a minimize button 402, a resizing button 404, a close button 406, a pull-down menu 408, a volume indicator 410, a slider 412 which is slidable by an operation by the user, etc.

The minimize button 402 is a button for minimizing the size of the volume control user interface displayed on the LCD 115. The resizing button 404 is a button for changing the size of the volume control user interface displayed on the LCD 115 from the maximum size to a size arbitrarily set by the user, or from the size arbitrarily set by the user to the maximum size. The close button 406 is a button for ending the display of the volume control user interface on the LCD 115. When the pull-down menu 408 is clicked by the user, the pull-down menu 408 displays a list of available sound devices.

In the volume control user interface shown in FIG. 4, the volume indicator 410 is realized as a slider bar. By dragging and moving a slider 412 to the right side (maximum volume: MAX) or to the left side (minimum volume: MIN) of FIG. 4, it is possible to control the volume of sound output from the speakers 128a and 128b at the time of an IP telephone call.

FIG. 5 is an exemplary schematic diagram showing another example of the volume control user interface provided by the IP telephone software 204. In FIG. 5, those parts corresponding to the parts shown in FIG. 4 are designated by the same reference numerals, and a description thereof is omitted.

In the volume control user interface shown in FIG. 5, the volume indicator 510 is realized as a button. The button includes a volume increase button 512 and a volume decrease button 514. When the user starts clicking the volume increase button 512, output of the audio sample data is started. The volume of the audio sample data is increased in accordance with the time length the user continues clicking of the volume increase button 512. When the user ends the volume control operation, i.e., when the user ends clicking of the volume increase button 512, output of the audio sample data is ended.

On the other hand, when the user starts clicking of the volume decrease button 514, output of the audio sample data is also started. The volume of the audio sample data is decreased in accordance with the time length the user continues clicking the volume decrease button 514. When the user ends the volume control operation, i.e., when the user ends clicking of the volume decrease button 514, output of the audio sample data is ended.

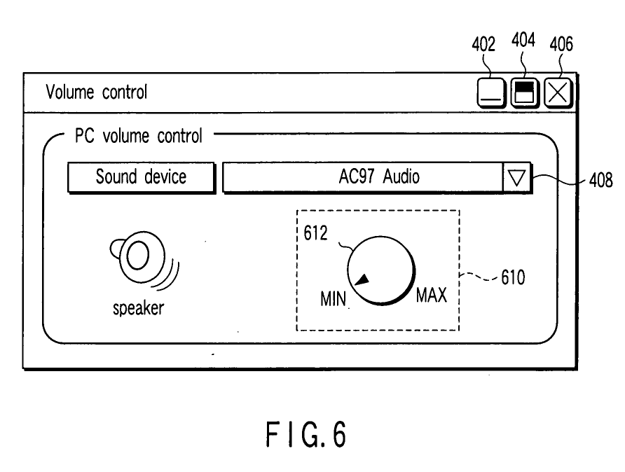

FIG. 6 is an exemplary schematic diagram showing still another embodiment of the volume control user interface provided by the IP telephone software 204. In FIG. 6, those parts corresponding to the parts shown in FIG. 4 are designated by the same reference numerals, and a description thereof is omitted.

In the volume control user interface shown in FIG. 6, a volume indicator 610 is realized as a dial which is rotatable by the user by using the mouse 121 or the like. When the user starts dragging of the dial 612, output of the audio sample data is started. By rotating the dial 612 in a clockwise direction (toward maximum volume: MAX) or in a counterclockwise direction (toward minimum volume: MIN) while dragging the dial 612, it is possible for the user to control the volume of sound output from the speakers 128a and 128b. When the user ends the volume control operation, i.e., when the user ends dragging of the dial 612, output of the audio sample data is ended.

With the above-mentioned information processing apparatus (the notebook PC 100) according to the first embodiment of the invention, output of the audio sample data is started at the same time when the volume control operation is started, the volume of the audio sample data is varied in accordance with the control by the user during the volume control operation, and the output of the audio sample data is ended at the same time when the volume control is ended. Accordingly, it is possible to control the volume with a simple operation.

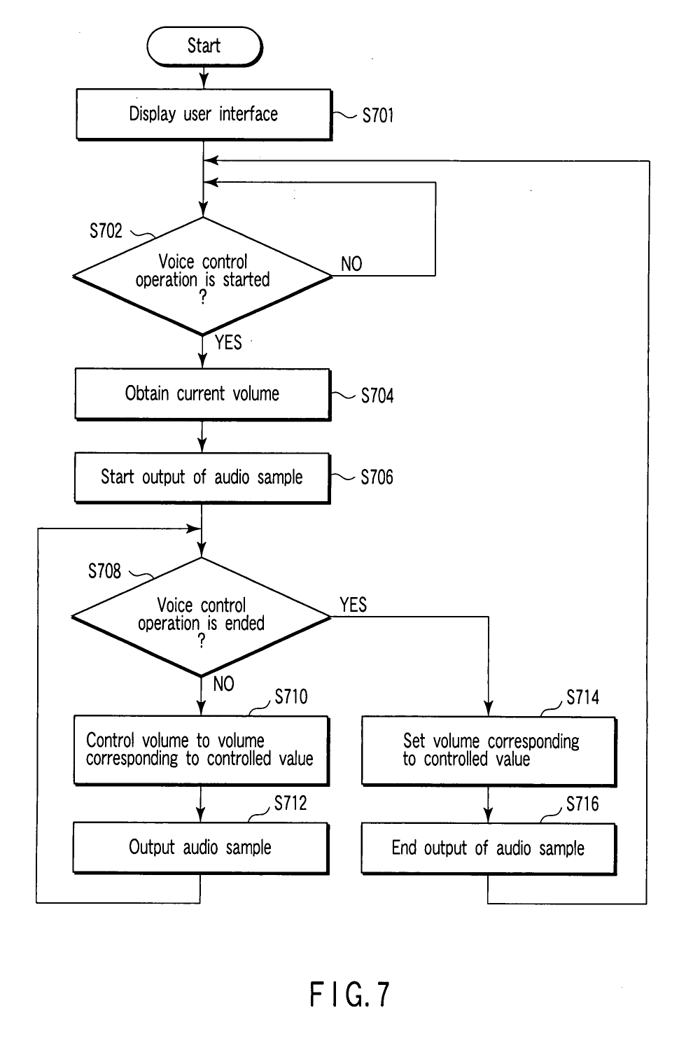

Referring to FIG. 7, a description is given of a volume control method according to a second embodiment of the invention.

FIG. 7 is an exemplary flowchart for explaining the volume control method according to the second embodiment of the invention. The volume control method can be applied to various information processing apparatuses including the notebook PC 100 shown in FIG. 1. For convenience of explanation, a description is given below of an exemplary case where the volume control method according to the second embodiment of the invention is applied to the notebook PC 100.

The user interface displaying unit 224 displays on the LCD 115 of the notebook PC 100 the volume control user interface for controlling the volume of audio data output from the audio output unit 127 (block S701). The determining unit 214 determines whether or not the volume control operation by the user is started via the volume control user interface displayed on the LCD 115 (block S702). The determination is conducted based on, for example, a signal supplied from the OS 202 to the IP telephone software 204. Block S702 is repeated until the volume control operation by the user is started (NO in block S702).

When it is determined that the volume control operation by the user is started (YES in block S702), the volume obtaining unit 216 obtains the volume currently set to the IP telephone software 204 (e.g., the volume stored in the registry 211 shown in FIG. 2) (block S704).

When the currently set volume is obtained by the volume obtaining unit 216, the audio output unit 127 starts output of the audio sample data with the obtained volume (block S706). In the case where the plurality of kinds of audio sample data are prepared, it is possible to output the audio sample data selected by the user. Additionally, in this case, when the user does not select any audio sample data, the audio sample data which are set in the initial setting may be output.

After the output of the audio sample data is started, the determining unit 214 determines whether or not the volume control operation by the user is ended (block S708). When the volume control operation by the user is not ended (NO in block S708), the volume controlling unit 218 controls the volume of the audio sample data to volume corresponding to the controlled value in accordance with information which is based on the volume control operation and is supplied from the determining unit 214 (block S710). The audio output unit 127 outputs the audio sample data with the volume corresponding to the controlled value (block S712). The process from blocks S708 to S712 is repeated until the volume control operation by the user is ended, i.e., during the volume control operation by the user.

On the other hand, when the determining unit 214 determines that the volume control operation by the user is ended (YES in block S708), the volume setting unit 222 sets volume corresponding to the value which is finally controlled (block S714). More specifically, the volume setting unit 222 stores in the registry 211 the volume corresponding to the value finally controlled. After the volume setting by the volume setting unit 222, the audio sample data supplying unit 220 ends output of the audio sample data (block S716). Then, the process returns to block S702.

With the above-mentioned volume control method according to the second embodiment of the invention, output of the audio sample data is started at the same time when the volume control operation is started, the volume of the audio sample data is varied in accordance with the control by the user during the volume control operation, and the output of the audio sample data is ended at the same time when the volume control is ended. Accordingly, it is possible to control the volume with a simple operation.

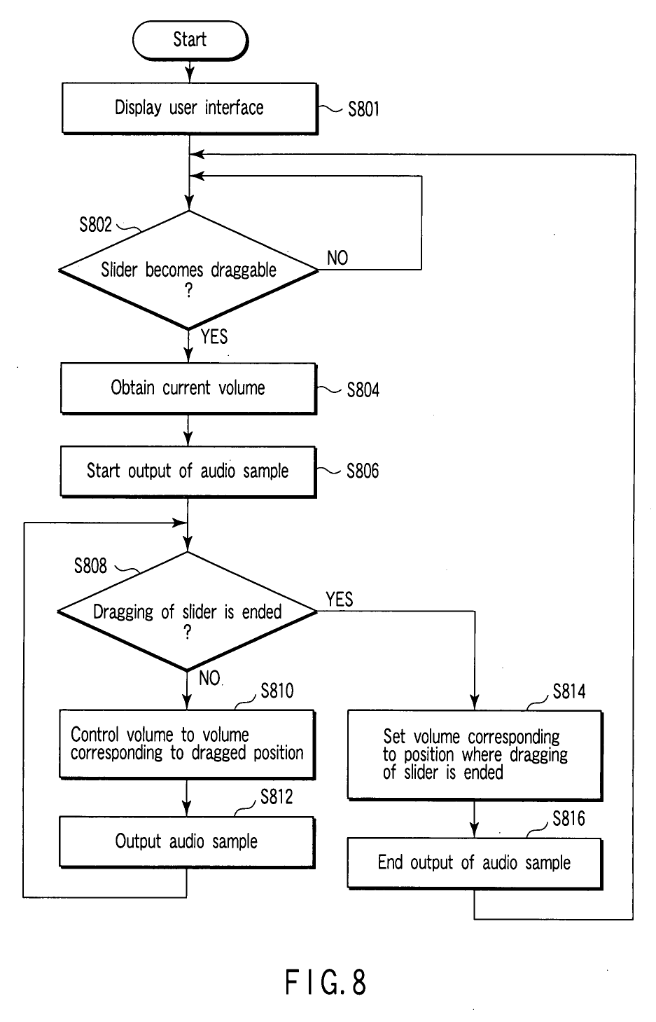

Referring to FIG. 8, a description is given of a specific exemplary application of the volume control method according to the second embodiment of the invention.

FIG. 8 is an exemplary flowchart for explaining the specific exemplary application of the volume control method according to the second embodiment of the invention. In this example, the volume control user interface of the IP telephone software 204 includes a slider bar as the volume indicator. Hereinafter, for convenience of explanation, it is assumed that the volume control user interface shown in FIG. 4 is provided by the IP telephone software 204.

The user interface displaying unit 224 displays the volume control user interface for controlling the volume of the audio output unit 127 on the LCD 115 of the notebook PC notebook PC 100 (block S801). The determining unit 214 determines whether or not the volume control operation by the user is started, i.e., whether the user starts dragging of the slider 412 via the volume control user interface displayed on the LCD 115 (block S802). The determination is conducted based on, for example, a signal supplied from the OS 202 to the IP telephone software 204. Block S802 is repeated until the volume control operation by the user is started (NO in block S802).

When it is determined that the volume control operation by the user is started (YES in block S802), the volume obtaining unit 216 obtains the volume currently set to the notebook PC 100 or the IP telephone software 204 (block S804).

When the currently set volume is obtained by the volume obtaining unit 216, the audio sample data supplying unit 220 starts output of the audio sample data (block S806). In the case where the plurality of kinds of audio sample data are prepared, it is possible to output the audio sample data selected by the user. Additionally, in this case, when the user does not select any audio sample data, the audio sample data which are set in the initial setting may be output.

After the output of the audio sample data is started, the determining unit 214 determines whether or not the volume control operation by the use is ended, i.e., whether or not the user ends dragging of the slider 412 (block S808). When the volume control operation by the user is not ended (NO in block S808), the volume controlling unit 218 controls the volume of the audio sample data to volume corresponding to the controlled value based on information which indicates the volume control operation and is supplied from the determining unit 214 (block S810). The audio output unit 127 outputs the audio sample data with the volume supplied from the volume controlling unit 218, i.e., the volume corresponding to the position to which the slider 412 is moved (block S812). The process of blocks S808 through S812 is repeated until the volume control operation by the user is ended, i.e., during the volume control operation by the user.

On the other hand, when the determining unit 214 determines that the volume control operation by the user is ended, i.e., the user ends dragging of the slider 412 (YES in block S808), the volume setting unit 222 sets, to the notebook PC 100, the finally controlled value, i.e., the volume corresponding to the final position of the slider 412 (block S814). More specifically, the volume setting unit 222 stores in the registry 211 the volume corresponding to the finally controlled value. After the volume setting by the volume setting unit 222, the audio sample data supplying unit 220 ends output of the audio sample data (block S816). Then, the process returns to block S802.

With the above-mentioned exemplary application, output of the audio sample data is started at the same time when the volume control operation is started, the volume of the audio sample data is varied in accordance with the control by the user during the volume control operation, and the output of the audio sample data is ended at the same time when the volume control is ended. Accordingly, it is possible to control the volume with a simple operation.

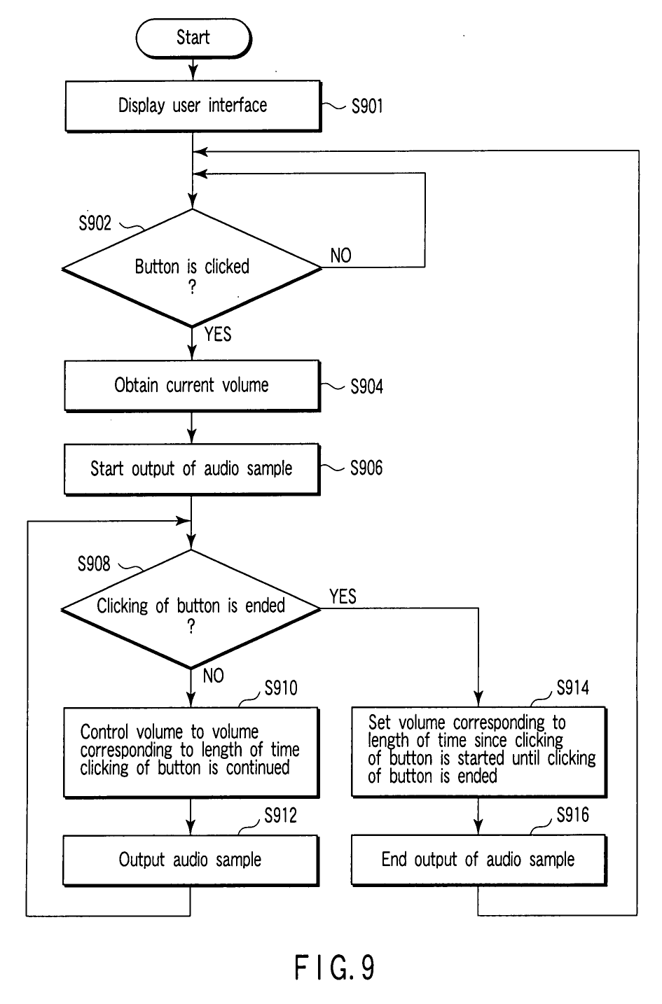

Referring to FIG. 9, a description is given of another specific exemplary application of the volume control method according to the second embodiment of the invention.

FIG. 9 is an exemplary flowchart for explaining another specific exemplary application of the volume control method according to the second embodiment of the invention. In this example, the volume control user interface of the IP telephone software 204 includes a button as the volume indicator. Hereinafter, for convenience of explanation, it is assumed in this example that the volume control user interface shown in FIG. 5 is provided by the IP telephone software 204.

The user interface displaying unit 224 displays the volume control user interface for controlling the volume of the audio output unit 127 on the LCD 115 of the notebook PC notebook PC 100 (block S901). The determining unit 214 determines whether or not the volume control operation by the user is started, i.e., whether the user starts clicking of the button 512 or the button 514 via the volume control user interface (see FIG. 5) displayed on the LCD 115 (block S902). The determination is conducted based on, for example, a signal supplied from the OS 202 to the IP telephone software 204. Block S902 is repeated until the volume control operation by the user is started (NO in block S902).

When it is determined that the volume control operation by the user is started (YES in block S902), the volume obtaining unit 216 obtains the volume currently set to the notebook PC 100 or the IP telephone software 204 (block S904).

When the currently set volume is obtained by the volume obtaining unit 216, the audio sample data supplying unit 220 starts output of the audio sample data (block S906). In the case where the plurality of kinds of audio sample data are prepared, it is possible to output the audio sample data selected by the user. Additionally, in this case, when the user does not select any audio sample data, the audio sample data which are set in the initial setting may be output.

After the output of the audio sample data is started, the determining unit 214 determines whether or not the volume control operation by the user is ended, i.e., whether or not the user ends clicking of the button 512 or the button 514 (block S908). When the volume control operation by the user is not ended (NO in block S908), the volume controlling unit 218 controls the volume of the audio sample data to volume corresponding to the length of time the clicking of the button 512 or the button 514 is continued based on information which indicates the volume control operation and is supplied from the determining unit 214 (block S910). The audio output unit 127 outputs the audio sample data with the volume supplied from the volume controlling unit 218, i.e., the volume corresponding to the length of time the clicking of the button 512 or the button 514 is continued (block S912). The process from block S908 to S912 is repeated until the volume control operation by the user is ended, i.e., during the volume control operation by the user.

On the other hand, when the determining unit 214 determines that the volume control operation by the user is ended, i.e., the user ends clicking of the button 512 or the button 514 (YES in block S908), the volume setting unit 222 sets, to the notebook PC 100, the finally controlled value, i.e., the volume corresponding to the length of time since the clicking of the button 512 or the button 514 is started until the clicking is ended (block S914). More specifically, the volume setting unit 222 stores in the registry 211 the volume corresponding to the finally controlled value. After the volume setting by the volume setting unit 222, the audio sample data supplying unit 220 ends output of the audio sample data (block S916). Then, the process returns to block S902.

With the above-mentioned exemplary application, output of the audio sample data is started at the same time when the volume control operation is started, the volume of the audio sample data is varied in accordance with the control by the user during the volume control operation, and the output of the audio sample data is ended at the same time when the volume control is ended. Accordingly, it is possible to control the volume with a simple operation.

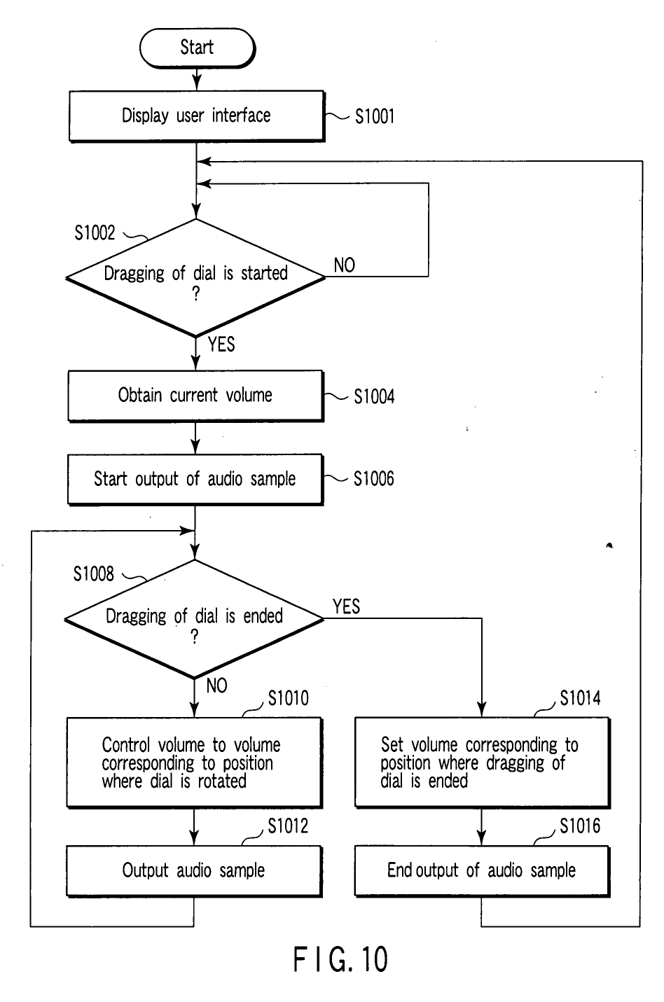

Referring to FIG. 10, a description is given of still another specific exemplary application of the volume control method according to the second embodiment of the invention.

FIG. 10 is an exemplary flowchart for explaining the specific exemplary application of the volume control method according to the second embodiment of the invention. In this example, the volume control user interface of the IP telephone software 204 includes a dial as the volume indicator. Hereinafter, for convenience of explanation, it is assumed in this exemplary application that the volume control user interface shown in FIG. 6 is provided by the IP telephone software 204.

The user interface displaying unit 224 displays the volume control user interface for controlling the volume of the audio output unit 127 on the LCD 115 of the notebook PC notebook PC 100 (block S1001). The determining unit 214 determines whether or not the volume control operation by the user is started, i.e., whether the user starts dragging of the dial 612 via the volume control user interface (see FIG. 6) of the IP telephone software 204 displayed on the LCD 115 (block S1002). The determination is conducted based on, for example, a signal supplied from the OS 202 to the IP telephone software 204. Block S1002 is repeated until the volume control operation by the user is started (NO in block S1002).

When it is determined that the volume control operation by the user is started (YES in block S1002), the volume obtaining unit 216 obtains the volume currently set to the notebook PC 100 or the IP telephone software 204 (block S1004).

When the currently set volume is obtained by the volume obtaining unit 216, the audio sample data supplying unit 220 starts output of the audio sample data (block S1006). In the case where the plurality of kinds of audio sample data are prepared, it is possible to output the audio sample data selected by the user. Additionally, in this case, when the user does not select any audio sample data, the audio sample data which are set in the initial setting may be output.

After the output of the audio sample data is started, the determining unit 214 determines whether the volume control operation by the use is ended, i.e., whether the user ends dragging of the dial 612 (block S1008). When the volume control operation by the user is not ended (NO in block S1008), the volume controlling unit 218 controls the volume of the audio sample data to volume corresponding to the position where the dial 612 is rotated based on information which indicates the volume control operation and is supplied from the determining unit 214 (block S1010). The audio output unit 127 outputs the audio sample data with the volume supplied from the volume controlling unit 218, i.e., the volume corresponding to the position of the dial 612 (block S1012). The process from block S1008 to S1012 is repeated until the volume control operation by the user is ended, i.e., during the volume control operation by the user.

On the other hand, when the determining unit 214 determines that the volume control operation by the user is ended, i.e., the user ends dragging of the dial 612 (YES in block S1008), the volume setting unit 222 sets, to the notebook PC 100, the finally controlled value, i.e., the volume corresponding to the position of the dial 612 when the dragging of the dial 612 is ended (block S1014). More specifically, the volume setting unit 222 stores in the registry 211 the volume corresponding to the finally controlled value. After the volume setting by the volume setting unit 222, the audio sample data supplying unit 220 ends output of the audio sample data (block S1016). Then, the process returns to block S1002.

With the above-mentioned exemplary application, output of the audio sample data is started at the same time when the volume control operation is started, the volume of the audio sample data is varied in accordance with the control by the user during the volume control operation, and the output of the audio sample data is ended at the same time when the volume control is ended. Accordingly, it is possible to control the volume with a simple operation.

It should be noted that each of the above-mentioned volume control methods (exemplary applications) can be realized as a program which can be executed by a computer. In this case, it is possible to obtain functions and effects similar to those mentioned above by installing the program on an information processing apparatus provided with a function of outputting audio.

In addition, each of the above-mentioned volume control methods (exemplary applications) is not limited to the order described above. For example, the process of blocks S714 and S716 shown in FIG. 7 may be performed simultaneously. Alternatively, the process of block S714 may be performed after performing the process of block S716. The same applies to the corresponding blocks shown in flowcharts shown in FIGS. 8, 9 and 10.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
an audio output unit which outputs input audio data;
a display;
a user interface displaying unit which displays, on the display, a volume control user interface for controlling volume of the audio data output from the audio output unit;
a storing unit which stores audio sample data;
a volume controlling unit which controls the volume of the audio data output from the audio output unit in accordance with a volume control operation by a user via the volume control user interface; and
an audio sample data supplying unit which supplies, to the audio output unit, the audio sample data stored in the storing unit during the volume control operation.

2. The information processing apparatus according to claim 1, further comprising:
a determining unit which determines whether or not the volume control operation is started, determines, after the volume control operation is started, whether or not the volume control is ended, outputs, when the volume control operation is not ended, information based on the volume control operation, and ends, when the volume control operation is ended, supplying of the audio sample data from the audio sample data supplying unit to the audio output unit; and
a volume obtaining unit which, when it is determined that the volume control operation is started, obtains volume currently set to the audio output unit and outputs the obtained volume,
wherein, when the volume control operation is started, the volume controlling unit controls the volume of the audio data to the volume output from the volume obtaining unit, and when the volume control operation is not ended after the volume control operation is started, the volume controlling unit controls the volume of the audio data based on the information output from the determining unit.

3. The information processing apparatus according to claim 1, wherein the volume control user interface includes a volume indicator, and
the audio sample data supplying unit supplies the audio sample data to the audio output unit while the volume indicator is operated.

4. The information processing apparatus according to claim 3, wherein the volume indicator is a slider bar including a slider which is slidable by a user operation, and
the audio sample data supplying unit supplies the audio sample data to the audio output unit while the slider is draggable.

5. The information processing apparatus according to claim 3, wherein the volume indicator is a button which is clickable by a user operation, and
the audio sample data supplying unit supplies the audio sample data to the audio output unit while clicking of the button is continued.

6. The information processing apparatus according to claim 3, wherein the volume indicator is a dial which is rotatable by a user operation, and
the audio sample data supplying unit supplies the audio sample data to the audio output unit while the dial is draggable.

7. The information processing apparatus according to claim 1, further comprising:
a call processing unit configured to receive audio data supplied via an IP telephone network connected to the information processing apparatus,
wherein the audio sample data include background noise.

8. The information processing apparatus according to claim 1, wherein the storing unit stores a plurality of kinds of audio sample data.

9. A volume control method, comprising:
displaying, on a display, a volume control user interface for controlling volume of audio data output from an audio output unit;
determining whether or not a volume control operation by a user is started via the volume control user interface;
obtaining, when it is determined that the volume control operation is started, currently set volume;
starting output of audio sample with the obtained volume;
determining, after the volume control is started, whether or not the volume control operation is ended;
controlling, when it is determined that the volume control operation is not ended, the volume of the audio data to volume corresponding to a value controlled in the volume control operation;
outputting the audio sample with the controlled volume; and
ending output of the audio sample when it is determined that the volume control operation is ended.

10. The volume control method according to claim 9, wherein the displaying, on the display, the volume control user interface comprises:
displaying, on the display, a volume control user interface including a volume indicator, and
the determining whether or not the volume control operation is started comprises:
determining whether or not the volume control operation is started based on whether or not the volume indicator is operated, and determining whether or not the volume control operation is ended based on whether or not an operation of the volume indicator is ended.

11. The volume control method according to claim 10, wherein the displaying, on the display, the volume control user interface comprises:
displaying, on the display, a slider bar including a slider which is slidable by a user operation, and
the determining whether or not the volume control operation is started comprises:
determining whether or not the volume control operation is started based on whether or not the slider becomes draggable, and determining whether or not the volume control operation is ended based on whether dragging of the slider is continued.

12. The volume control method according to claim 10, wherein the displaying, on the display, the volume control user interface comprises:
displaying, on the display, a button which is clickable by an user operation, and
the determining whether or not the volume control operation is started comprises:
determining whether or not the volume control operation is started based on whether clicking of the button is started, and determining whether or not the volume control operation is ended based on whether the clicking of the button is continued.

13. The volume control method according to claim 10, wherein the displaying, on the display, the volume control user interface comprises:
displaying, on the display, a dial which is rotatable by a user operation, and
the determining whether or not the volume control operation is started comprises:
determining whether or not the volume control operation is started based on whether the dial becomes draggable, and determining whether or not the volume control operation is ended based on whether dragging of the dial is continued.
